(19) United States
(12) Patent Application Publication
(10) Pub. No.: US 2018/0139717 A1
(43) Pub. Date: May 17, 2018

(54) APPARATUS AND METHOD FOR ASSESSING A RELATIVE DISTANCE OF PERSONS AND OBJECTS

(71) Applicant: HISEP TECHNOLOGY LTD., Yavne (IL)

(72) Inventors: Gad VERED, Be'er Ya'akov (IL); Yariv ERAD, Kidron (IL); Uri VERED, Rishon Leziyon (IL); Menachem Erad, Ashdod (IL)

(21) Appl. No.: 15/579,197

(22) PCT Filed: Jun. 2, 2016
(86) PCT No.: PCT/IL2016/050575

§ 371 Date: Dec. 2, 2017

Related U.S. Application Data
(60) Provisional application No. 62/169,575, filed on Jun. 2, 2015.
(60) Provisional application No. 62/175,376, filed on Jun. 14, 2015.

(51) Int. Cl. H04W 64/00

(52) U.S. Cl. CPC H04W 64/00; H04L 67/12

(57) ABSTRACT

The present invention discloses a method to determine the relative distance between electronic devices, by having a main electronic device communicating with at least two electronic devices in a wireless manner, the method comprising changing in a controlled manner a communication parameter used in the wireless communication between the main device and the said electronic devices, conducting wireless communication between said main device to each of the said other devices after each change of parameter, logging if receiving wireless signals from each one of the said two electronic devices for each said change of the communication parameter in said changed state, determining at the main electronic device that one of the at least two electronic devices is closer or further-away than the other electronic device of the at least two electronic devices in relation to the main device.

### FIELD OF THE INVENTION

The invention generally relates to assessing relative distance of persons and objects from a reference point, and more specifically to assessing the relative distance of persons and objects associated with a computerized or electronic device.

### BACKGROUND OF THE INVENTION

The growing proliferation of IOT (Internet of things) devices in recent years presents users with new ways to connect, control, monitor, and discover these devices. As IOT is basically about short ranges, in many cases a user can see in his eyes the objects he is interacting with. Therefore, the intuitiveness element of locating the object near the user has a bigger implication and significance.

In addition, providing a user with information about the relative direction and the relative distance of an object from the user enables the user to know the relative location of items around him/her. Similarly to users, some electronic devices also need to know the relative location of other objects in their vicinity, in order to perform various functions.

There are some methods known in the art that are used to measure absolute distance from other objects. In most of those methods, the outcome is translated into a distance unit—meter/feet/etc. methods for assessing relative distance of objects enable a computerized object to determine if object A is closer/same/farther away from object B—whereas point C serves as the reference point.

The term “Relative Distance”—shall refer to relations and/or degrees of proximity between at least 2 devices—not based on length distance/range standard units. Examples of an outcome of a relative assessment may be which object is closer or farther to a reference point.

There are several techniques to assess the distance to a device using RF, as disclosed below, each has its drawbacks.

The RSSI (received signal strength indication) technique is based on the notion that the farther the device, the weaker the received signal strength. If the transmitted power is known and if the wave propagation follows the free space conditions, then by measuring the received signal strength it is possible to calculate the distance using a simple equation.

Measuring distance using RSSI is not accurate enough since in reality wave propagation does not behave as in free space conditions when one is located near the ground, let alone if one is in a built up area or within a building. Therefore, the signal suffers from reflections, b. RSSI change vs. distance is not necessarily monotonous with distance and RSSI is not stable in time.

Another RF-based technique for relative distance is Fingerprinting (or signature), which is based on extensive measurements and mapping of the reception of a multitude of known RF transmitting sources in a predefined area. The transmitting sources may be Wi-Fi routers, cell towers etc. Each location in the mapped area has a list of the expected RSSI (or AOA—Angle of Arrival) from each transmitting source, which is the fingerprint of the location. For location finding, the RSSI (or AOA) from each of the transmitting sources is measured and compared to the fingerprint database and the best fit indicates the location and distance to each source.

Fingerprinting techniques suffer from following drawbacks: 1. It requires relying on a-priori prepared infrastructure. 2. There is a need for significance preliminary measurements. 3. It only functions in mapped areas in which the locations of towers are known a-priori. 4. It cannot cope with changes in the infrastructure e.g. variations in transmitted power.

In view of the above, there is a need for a method to assess relative distance between objects using wireless communication that overcomes the abovementioned drawbacks.

### SUMMARY OF THE INVENTION

It is an object of the invention to disclose a method to determine the relative distance between electronic devices, by having a main electronic device communicating with at least two electronic devices in a wireless manner, the method comprising changing in a controlled manner a communication parameter used in the wireless communication between the main device and the said electronic devices conducting wireless communication between said main device to each of the said other devices after each change of parameter, logging if receiving wireless signals from each one of the said two electronic devices for each said change of the communication parameter in said changed state; and determining at the main electronic device that one of the at least two electronic devices is closer or further-away than the other electronic device of the at least two electronic devices in relation to the main device.

In some cases, the method further comprises changing in a controlled manner the communication parameter in the main electronic device and in one of the at least two electronic devices correspondingly.

In some cases, changing in a controlled manner a communication parameter comprises increasing or decreasing a value of the communication parameter.

In some cases, determining that one of the at least two electronic devices is closer than the other electronic device is achieved when communication between the main electronic device and another device reaches a predefined threshold.

In some cases, the predefined threshold is loss of communication between the main electronic device and another device. In some cases, the method further comprises marking a communication parameter value in which the communication between the main electronic device and another electronic device of the at least two electronic devices reaches the predefined threshold.

In some cases, the method further comprises displaying on a display device of the main electronic device the said other devices in their relative distance from the main device.

In some cases, the method is performed by one of the at least two electronic devices simultaneously to the method performed by the main electronic device.

In some cases, the method further comprises sharing and comparing relative distances between the main electronic device and one of the at least two electronic devices. In some cases, the method further comprises determining whether or not the results of the methods performed the main electronic device and one of the at least two electronic devices match.

In some cases, the communication parameter is bitrate. In some cases, the communication parameter is an attenuation level. In some cases, the communication parameter is Power Adjustment Back-off, and wherein the Power Adjustment Back-off value is broadcasted by the said two other devices while changed.

In some cases, the communication parameter is a radio frequency of the wireless communication. In some cases, the communication parameter is an audio frequency of the wireless communication. In some cases, the communication parameter is a light frequency of the wireless communication.

In some cases, the method further comprises capturing an image and analyzing the captured image; wherein determining at the main electronic device that one of the at least two electronic devices is closer or further-away than the other electronic device of the at least two electronic devices in relation to the main device is performed according to the analysis of the captured image.

It is another object of the invention to disclose a method performed in a system having at least 3 electronic devices communicating with each other in a wireless manner, the method comprising determining at each electronic device a relative direction to at least two electronic devices; sharing the relative direction determined electronic devices with other; determining at said electronic devices that one of the other two electronic devices is closer than the other electronic device. In some cases, plurality of devices in the system can determine the relative direction to other devices and share said data among the devices. In some cases, the relative direction comprises an azimuth from one electronic device to another.

It is another object of the invention to disclose a method performed on a main electronic device communicating with at least two electronic devices in a wireless manner, the method comprising: tracking a communication parameter used to communicate with the at least two electronic devices; receiving wireless signals from the at least two electronic devices in various values of the communication parameter; determining at the main electronic device that one of the at least two electronic devices is closer than another electronic device of the at least two electronic devices.

It is another object of the invention to disclose a method, comprising emitting an environmental-detectable material from an emitting device; wirelessly broadcasting the parameters of the emitted environmental-detectable material by the emitting device; measuring the environmental-detectable material parameters by a device having at least one sensor; receiving at the said device the wirelessly broadcasted parameters from the emitting device; comparing at the measuring device the measured parameters to the broadcasted parameters; determining a relative distance of the sensor from the device according to said comparison.

In some cases, the sensor detects air movement velocity. In some cases, the detectable material is air, gas, temperature, light and a combination thereof.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of assessing a relative distance of objects by increasing a rate of a wireless radio communication parameter, in accordance with a preferred embodiment of the present invention;

FIG. 2 shows a method of assessing a relative distance of objects by decreasing a rate of a communication parameter, in accordance with a preferred embodiment of the present invention;

FIG. 3 shows a visual representation of the relative distances of multiple electronic devices according to from the main electronic device, according to exemplary embodiments of the disclosed subject matter;

FIG. 4 shows a method of verifying a relative distance of objects by two electronic devices, in accordance with a preferred embodiment of the present invention;

FIG. 5 shows a method of estimating a quality of a relative distance assessment performed by two or more electronic devices, in accordance with a preferred embodiment of the present invention;

FIG. 6 shows a visual representation in which multiple electronic devices act as a main electronic device, according to exemplary embodiments of the disclosed subject matter;

FIG. 7 shows a smart phone's display shows a visual representation of relative distance of other devices, according to exemplary embodiments of the disclosed subject matter;

FIG. 8 shows a method of assessing relative distance of other devices by increasing attenuation, according to exemplary embodiments of the disclosed subject matter;

FIG. 9 shows a method of assessing relative distance of other devices by decreasing attenuation, according to exemplary embodiments of the disclosed subject matter;

FIGS. 10 and 11 show a use of finding the relative direction between devices in order to determine their relative distance, according to exemplary embodiments of the invention;

FIG. 12 shows a computerized environment for assessing a relative distance using audio signals, according to exemplary embodiments of the disclosed subject matter;

FIG. 13 shows a computerized environment for assessing a relative distance using sensors, according to exemplary embodiments of the disclosed subject matter;

FIG. 14 shows a computerized environment for assessing a relative distance using light, according to exemplary embodiments of the disclosed subject matter; and,

FIG. 15 shows a group of devices assessing a relative distance of each other, according to exemplary embodiments of the disclosed subject matter.

### DETAILED DESCRIPTION OF THE INVENTION

The present invention discloses a system and a method for assessing a relative distance of objects from a reference point, as both the reference point and the objects are associated with electronic devices capable of communicating wirelessly. The reference point is associated with a main electronic device and each of the other objects is associated with an electronic device communicating with the main electronic device. The method discloses changing in a controlled manner a communication parameter used in the wireless communication between a main electronic device and the two electronic device, while conducting wireless communication between the devices. Then, the method discloses logging whether or not wireless signals are received at the main electronic device from each of the other electronic devices and determining at the main electronic device the relative location of the other electronic devices from the main electronic device. Such determination may be made according to characteristics of the received signals.

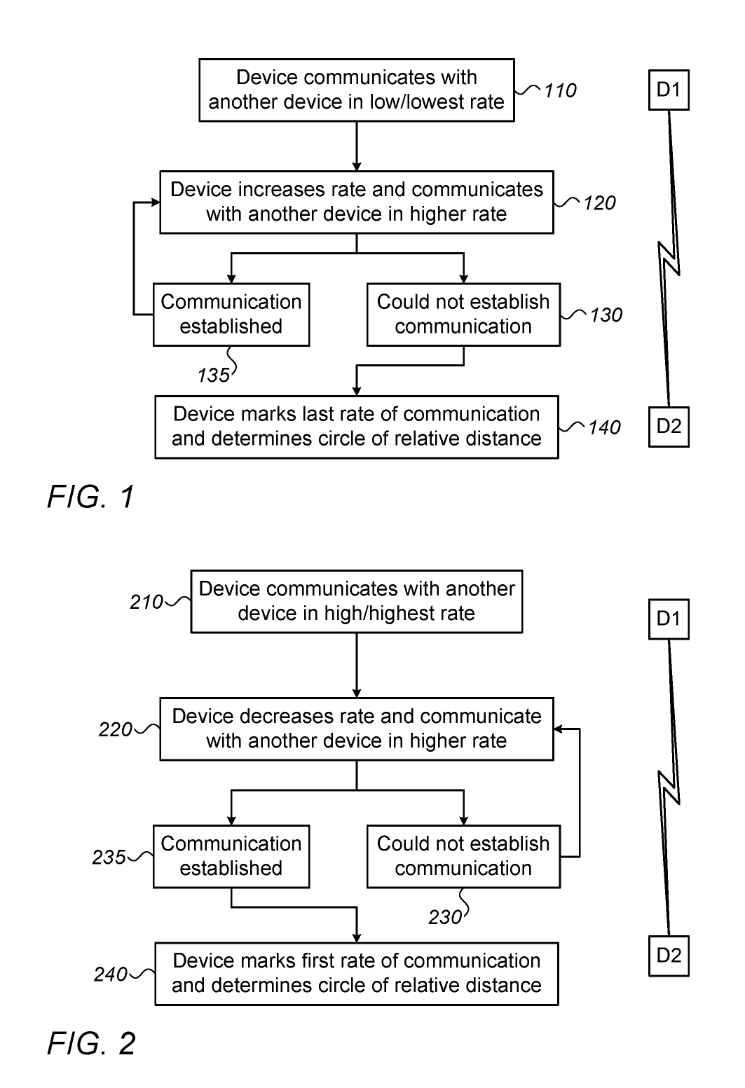

FIG. 1 shows a method of assessing a relative distance of objects by increasing a rate of a wireless radio communication parameter, in accordance with a preferred embodiment of the present invention. The invention provides assessing relative distance by changing a communication parameter in a controlled manner. In FIG. 1 the change is increasing, while in FIG. 2 the change is decreasing. The method is performed while conducting a wireless communication between a main electronic device and at least two other electronic devices. The outcome of the method is an assessment as to which of the at least two electronic devices is closer or farther away from the main electronic device. The main electronic device functions as a reference point.

In step 110, wireless communication is conducted between the main electronic device and the other electronic devices. Such other electronic devices may include an antenna for transmitting and receiving signals, and a control unit used to regulate the communication parameter in each electronic device. The communication parameter is changed in a controlled manner in both the main electronic device and the electronic devices communicating with it. The electronic devices may be sensors of an IOT module, cellular phones, tablet computers, laptop computers, gaming consoles and the like. The wireless communication may be peer-to-peer, via a server and the like. The wireless communication may be performed by a communication protocol desired by a person skilled in the art, such as Wi-Fi, Blue-tooth, 802.11 and the like.

Step 120 discloses increasing in a controlled manner a communication parameter used for the wireless communication between the main electronic device and the other devices. Such parameter may be bitrate, attenuation level, power adjustment back-off, communication frequency, bandwidth, signal amplitude and the like. In some cases, the communication parameter is changed in both the main electronic device and the other electronic devices. The manner in which the communication parameter may depend in a predefined set of rules, the rules may be effected by environmental conditions, according to a communication parameter, previous signals received from the electronic devices and the like. it should be noted that while in some cases the manner of changing the value of the communication parameter is influenced by the environment, the process of changing in order to assess the relative distance is commenced when the system or one of the devices requests to obtain relative distances of other devices, even if the current value of the communication parameter is optimal for communication purposes.

After increasing the communication parameter in a controlled manner, there are two options—either communication between the main electronic device and one of the electronic devices is established or maintained, as shown in step 130, or communication cannot be established or lost, as shown in step 135. In case communication cannot be established, the main electronic device marks the last value of the communication protocol in which the communication was established, along with an ID of the relevant electronic device with which communication could not be established after increasing the value of the communication parameter.

FIG. 2 shows a method of assessing a relative distance of objects by decreasing a rate of a communication parameter, in accordance with a preferred embodiment of the present invention. The method disclosed in FIG. 2 is substantially similar to the method elaborated in FIG. 1, but may be used for another communication parameter. For some communication parameters, communication is most likely to be established at the maximal level, or highest allowed level, and in order to assess the relative distance of several electronic devices from the main electronic device, the value of the communication protocol is decreased, as shown in step 220. After decreasing the value of the communication protocol, wireless communication between the main electronic device and one of the electronic devices is established, as shown in step 230, or cannot be established, as shown in step 235.

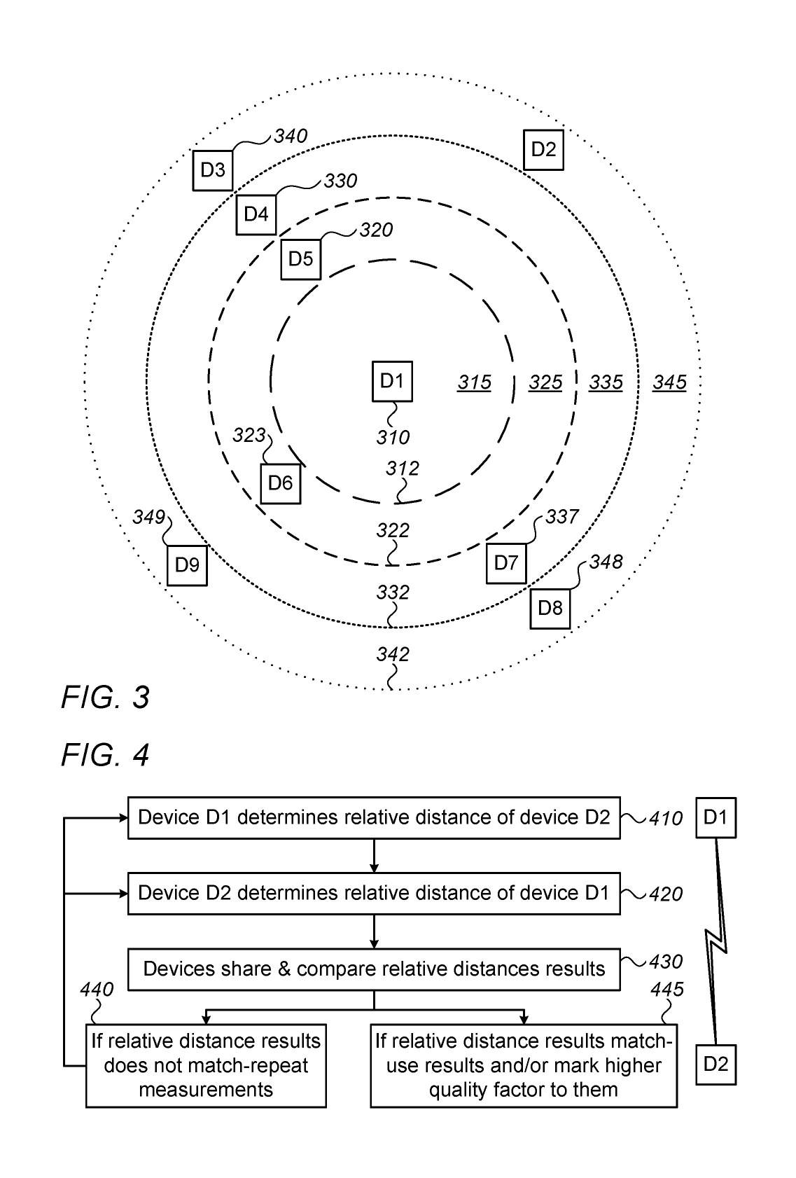

FIG. 3 shows a visual representation of the relative distances of multiple electronic devices according to from the main electronic device, according to exemplary embodiments of the disclosed subject matter. The multiple electronic devices communicate with the main electronic device 310. The visual representation is of a circular nature to show the relative distance of multiple electronic devices in various ranges. The ranges may be influenced by change of the communication parameter, and whether or not wireless communication is lost after changing the parameter.

The visual representation shows that none of the devices is in a close vicinity 315 to the main electronic device 310. Then, two electronic devices 320, 328 are associated with the first level 325. The first level 325 is defined between the first line 312 and second line 322. The actual distance of the electronic devices in the first level 325 may vary according to the communication parameter changed, from one geographic area to another, according to electronic sensitivity of the devices and the like. The visual representation shows that devices 320 and 328 are closer to the main electronic device 310 than devices 330 and 332 of the second level 335. Similarly, devices 330 and 332 are closer to the main electronic device 310 than devices 340, 348 and 349 of third level 345. The second level 335 is defined between the second line 322 and third line 332. The third level 345 is defined between the third line 332 and fourth line 342.

FIG. 4 shows a method of verifying a relative distance of objects by two electronic devices, in accordance with a preferred embodiment of the present invention. In step 410, one of the electronic devices assesses a relative distance of the electronic devices communicating with it. The relative distance method may be performed only in accordance with some of the electronic devices communicating with the first electronic device. The outcome of step 410 is the ability to know which devices are closer to the first electronic device than others, including a second electronic device, which performs the same assessment of relative distance in step 420. The outcome of step 420 is the ability to know which devices are closer to the second electronic device than others, including the first electronic device. In step 430, the first device and the second device exchange the results of steps 410 and 420 and check if the results match. That is, if a third device is assessed by the first device to be closer than the second device, the third device is also assessed by the second device to be closer than the first device. If there is a match in step 430, step 445 provides that the results of steps 410 and 420 are approved and can be used. In other cases, when there is a match, the results are assigned a quality factor that may be used later. If there is no match step 440 provides that the measurements are performed again.

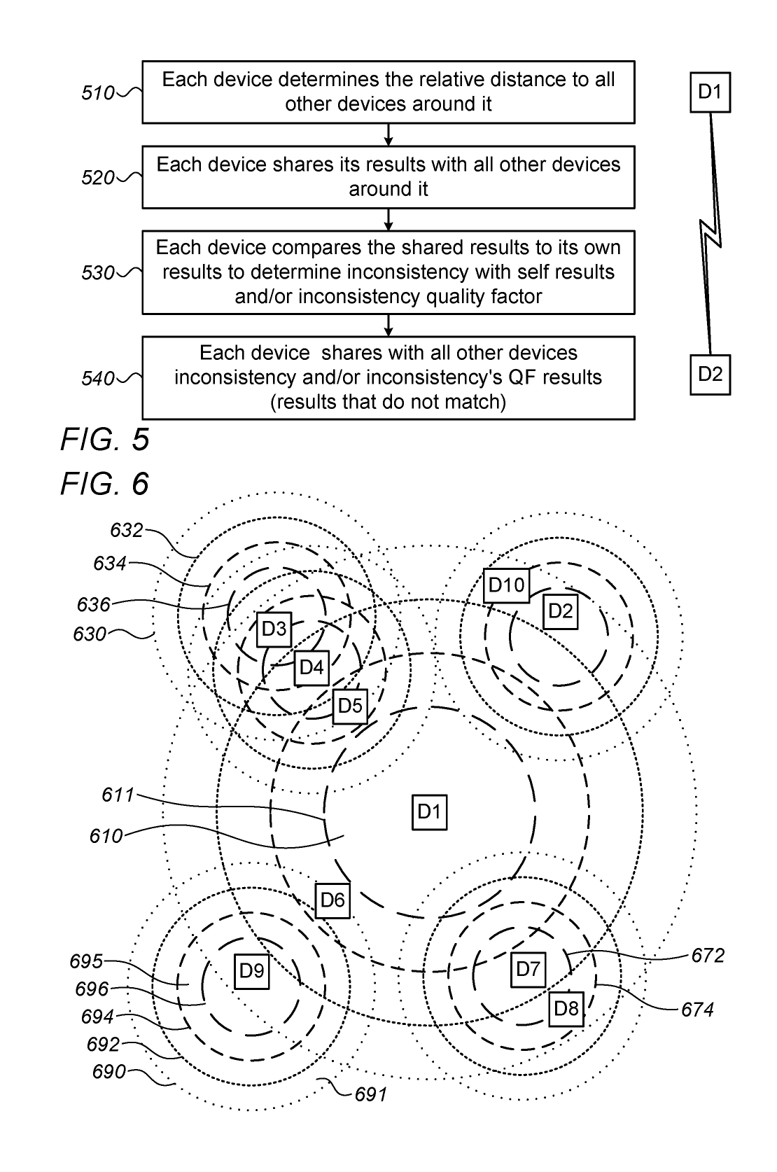

FIG. 5 shows a method of estimating a quality of a relative distance assessment performed by two or more electronic devices, in accordance with a preferred embodiment of the present invention. In step 510, each of the two or more electronic devices determines the relative distance of other electronic devices communicating with it. In such instance, each of the electronic devices is defined once as the main electronic device and determines which of the other devices is closer to or farther from it. Then, in step 520, the two or more electronic devices exchange the results of the relative distance determinations.

In step 530, the results of the relative distance determinations performed by the devices are compared. Comparing the results may be performed at the devices, or at a central device communicating with the devices. In some cases, one of the devices that performed the relative distance assessment is equipped with computational resources that enable it to perform the comparison. Then, the results of the comparison are converted into a quality factor (QF), which indicates the reliability of the assessment made by the devices. In step 540, the inconsistencies are exchanged between the devices, or sent from the central device to other devices.

FIG. 6 shows a visual representation in which multiple electronic devices act as a main electronic device, according to exemplary embodiments of the disclosed subject matter. D1 is a device defined as a main electronic device in a specific visual representation, for example for a specific user or for a specific smartphone. Devices D5 and D6 are closer to the main electronic device D1 than devices D4 and D7. Similarly, devices D4 and D7 are closer to the main electronic device D1 than devices D3 and D8, D2 and D9.

The visual representation enables the user of D1 to view the relative distances of other devices. For example, view which devices are closer to device D9 than others. That is, which devices are located at the first level 695 of device D9, which devices are at the third level 691 and the like. The user of D1 may change the visual representation by pressing on another device, and place the other device as the main electronic devices, if desired. For example, pressing on the screen at the area of device D2 and view D2 at the center, instead of D1.

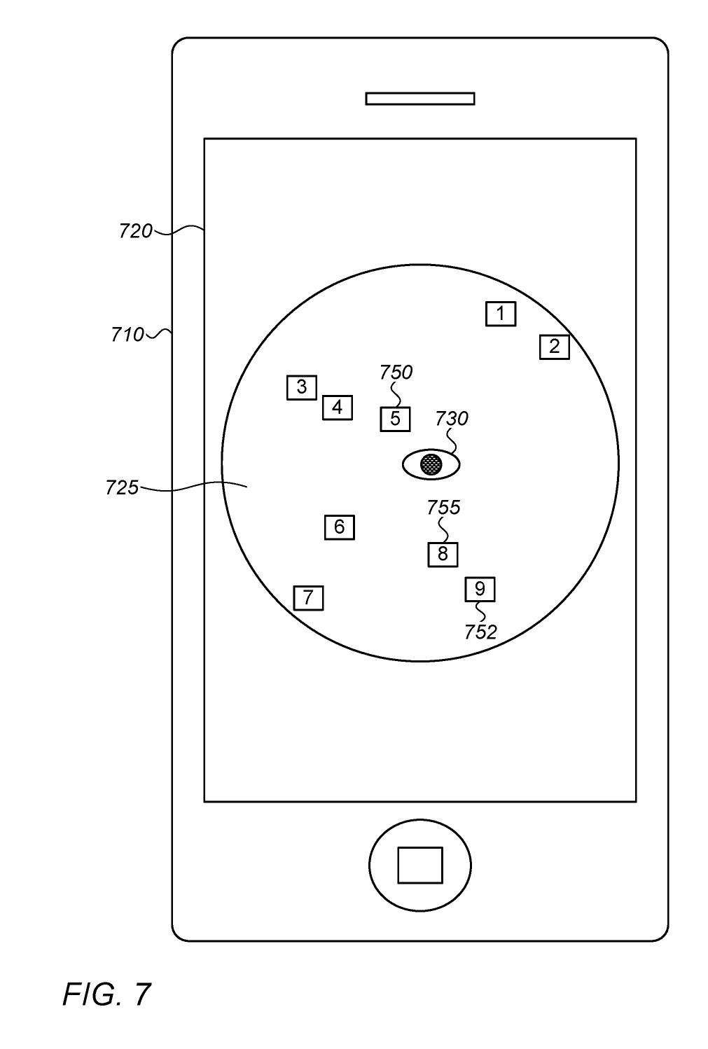

FIG. 7 shows a smart phone's display shows a visual representation of relative distance of other devices, according to exemplary embodiments of the disclosed subject matter. The smartphone 710 is an example of an electronic device with wireless capabilities and a display device 720. Other devices may be a tablet computer, a sensor, a laptop, smart watch, IOT devices, and the like. The visual representation 725 shows a main electronic device 730 at the center, and additional devices defined by a number. Alternatively, other devices may be defined by a username, type of device, an application running by the device, device's functionality (camera) and the like. The visual representation 725 of this exemplary embodiment lacks predefined levels of proximity in absolute distance units to the main electronic device 730, but shows proximity in general terms. That is, device #5 (750) is closer to the main electronic device 730 than devices #8 and #9 (755 and 752, respectively).

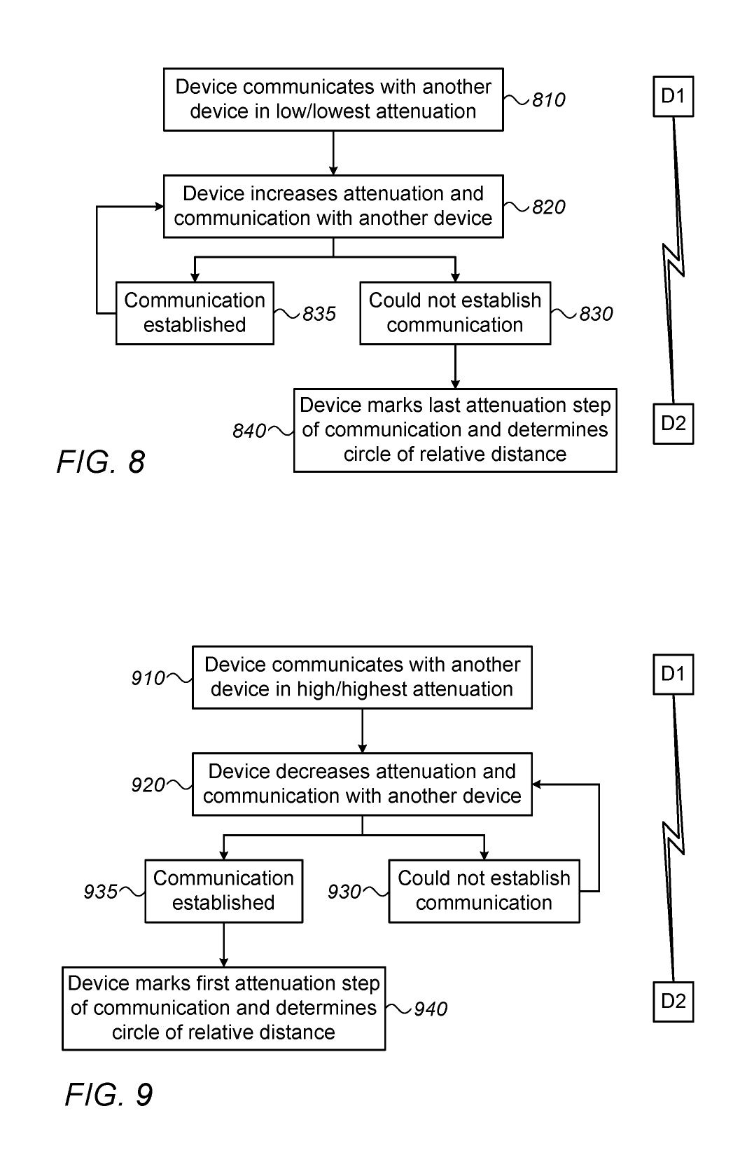

FIG. 8 shows a method of assessing relative distance of other devices by increasing attenuation, according to exemplary embodiments of the disclosed subject matter. In step 810, the main electronic device communicates with other devices wirelessly. At the beginning of the communication, the attenuation level is low. The term low may be a predefined level of attenuation in which communication is very likely to fail, or the lowest possible attenuation level of the devices. Then, in step 820, the main electronic device and the other devices increase the attenuation level in a controlled manner. After every such controlled change, the main electronic device logs if any signals are received from the other devices. If yes, as shown in step 835, communication between the main electronic device and the specific device associated with the received signal is indicated as established. If not, as shown in step 830, communication is not established. If the communication is not established, the main electronic device marks the attenuation step as shown in step 840 and increases the attenuation level and retry to establish communication. In some cases, the main electronic device marks such failure to establish communication as a level of relative distance with no devices.

FIG. 9 shows a method of assessing relative distance of other devices by decreasing attenuation, according to exemplary embodiments of the disclosed subject matter. In step 910, the main electronic device communicates with other devices wirelessly. At the beginning of the communication, the attenuation level is high. The term high may be a predefined level of attenuation in which communication is very likely to establish, or the highest possible attenuation level of the devices. Then, in step 920, the main electronic device and the other devices decrease the attenuation level in a controlled manner. After every such controlled change, the main electronic device logs if any signals are received from the other devices. If yes, as shown in step 935, communication between the main electronic device and the specific device associated with the received signal is indicated as established. If not, as shown in step 930, communication is not established. If the communication is established, the main electronic device marks the attenuation step and increases the attenuation level to find an attenuation level in which communication is lost, as shown in step 940. In some cases, the main electronic device marks such failure to establish communication as a level of relative distance with no devices.

In some exemplary cases, the communication parameter changed in a controlled manner is the power adjustment (PA) Back-off. When the PA back-off is increased, such change means that a device is broadcasting in less power, and vise-versa. By monitoring at the receiving device the PA back-off of the broadcasting device, the relative distance can be assessed. For that matter data concerning the PA back-off of the broadcasting device must be broadcasted to the receiving device.

For example, a receiving device may receive/discover/communicate with the broadcasting device when the PA is at relative low levels (i.e. few dB), and may fail to do so when in high levels (i.e. many dB)—indicating that the broadcasting device is relatively far. The less ability to receive/discover/communicate with the broadcasting device in low PA levels, may indicate that the broadcasting device is further away.

In some other cases, the communication parameter is data rate. Modem communications like LTE use techniques such as AMC (Adaptive Modulation and Coding) to dynamically give the user the highest possible data rate. When the device is closer to the main electronic device the system uses a higher data rate and when the device is further away it has to reduce the rate. The data rate used at a certain instance is an indicator to its relative distance.

The present invention comprises a method of tracking the dynamic rate that the communication module of the main electronic device uses. The lower the data rate, the closer the device. When two received devices use different data rates, this is an indication that the one using lower rate is relatively further away than the one using a higher data rate.

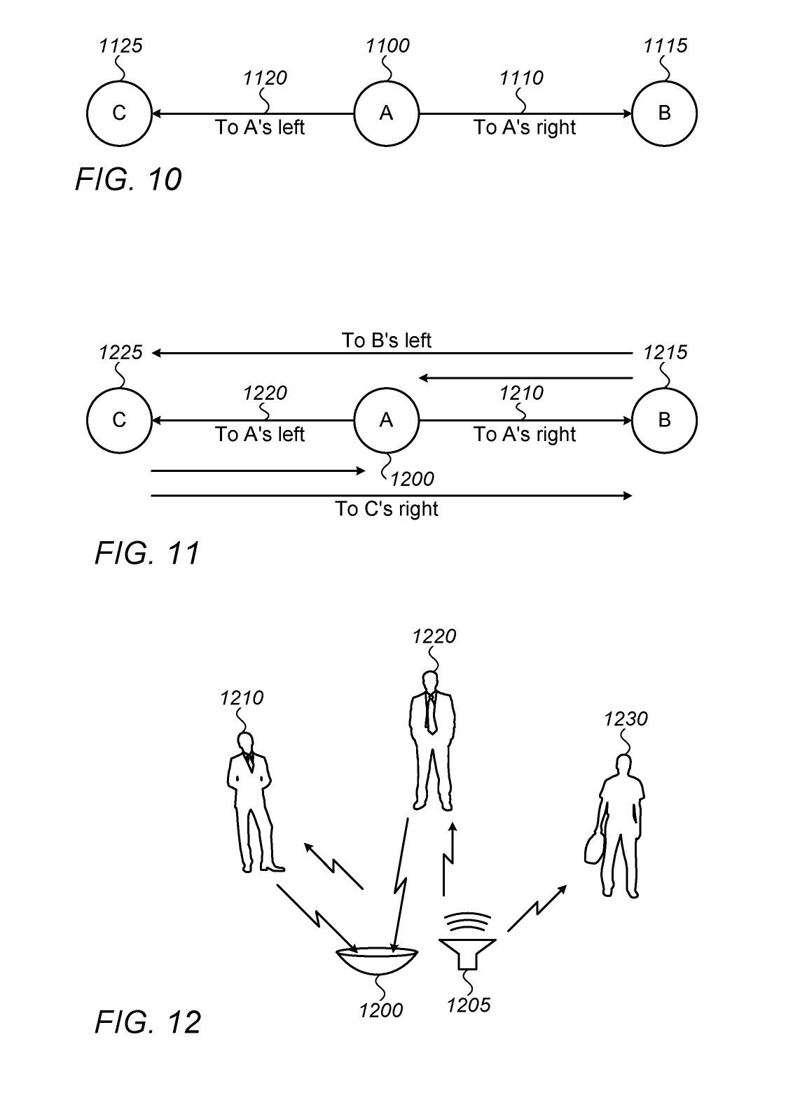

FIGS. 10 and 11 show a use of finding the relative direction between devices in order to determine their relative distance, according to exemplary embodiments of the invention. The relative direction may be performed by direct Peer-to-Peer (P2P) wireless communication. In FIG. 10, device A uses a relative direction finding method and determines that device B is to its right and device C is to the left. As a result—which can be seen in FIG. 11—when that information is sent to devices B and C, device C can determines that device A is closer to it than device B. similarly, device B determines that device A is closer to it than device C. in some cases, such determinations may also apply to cases in which the angle between the right line 1010 and the left line 1020 is less than 180 degrees, according to a predefined set of rules.

In FIG. 11, more than a single device calculates the relative direction of other devices and result of the relative direction assessment are shared among the devices. Hence, each of the devices can determine the relative distance of other devices using the relative direction, as shown in the image. That is, if device C determines that both devices A and B are to its left, and device A determines that device B is to its left, device C computes that device B is farther than device A. the same applies when the angle between the right line 1110 and the left line 1120 is less than 180 degrees.

FIG. 12 shows a computerized environment for assessing a relative distance using audio signals, according to exemplary embodiments of the disclosed subject matter. In the environment there are 3 persons 1210, 1220, 1230, each person has an electronic device that emits audio signals. Said signal can be in a frequency which is not heard by human beings. The emitted signals are received at a measuring device 1200 that functions as a reference point for measuring the relative distance of the electronic devices associated with persons 1210, 1220, 1230. The measuring device 1200 may determine the relative distance of the measured device, based on the received audio signal/data quality and/or strength. The measuring device 1200 may be equipped with a speaker 1205 emitting audio signals to the devices.

In some cases, image or video files captured by a camera may be used to assess the relative distance from the main electronic device. Said camera may be used to determine the relative size proportion of a Measured Device, for example, an air-condition unit equipped with a camera may use the camera to determine that a person X is farther from it than person Y. The measuring device may determine the relative distance of the measured device, based on the received audio signal/data quality and/or strength.

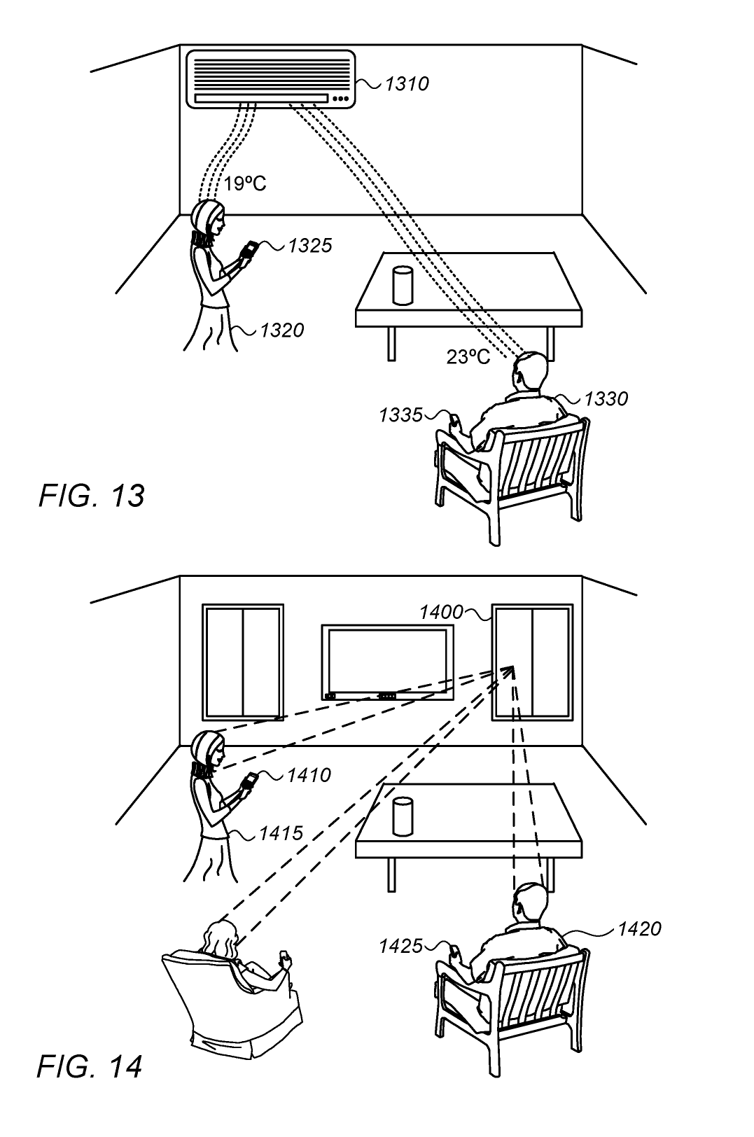

FIG. 13 shows a computerized environment for assessing a relative distance using sensors, according to exemplary embodiments of the disclosed subject matter. The sensor may communicate with an IOT device. The measuring device assesses a relative distance of two or more measured devices. The measuring device may receive sensor information from the measured devices, such as temperature, humidity, presence of gas or another material and the like. The data sensed by the measured devices 1325, 1335 used by persons 1320, 1330 respectively, is transmitted to the measuring device, which analyzes the sensed data to assess the relative distance. For example, in case the measuring device is an air condition unit 1310 emitting air in a predefined temperature, the measured devices 1325, 1335 may sense temperature and send it to the air condition unit 1310, and the device who sensed temperature closer to the temperature emitted from the air condition unit 1310 is assessed as closer to the air condition unit 1310. Such assessment may be updated periodically, for example once every 30 seconds.

In some other cases, the air condition unit 1310 functions as a measured device and one of the devices 1325, 1335 function as a measuring device. In another exemplary embodiment, the measuring device may include a sensor that can detect air movement speed and/or power. The measured device can be the air-condition unit 1310, and the data about its configured volume flow rate of air may be wirelessly sent to the measuring device 1325 (which can be a band, remote control unit, TOT object, mobile device, etc.). The difference (or delta) between the measured volume flow rate detected at the measuring device vs. the one configured at the measured device, can be used to indicate the relative distance between the measuring device and measured device.

FIG. 14 shows a computerized environment for assessing a relative distance using light, according to exemplary embodiments of the disclosed subject matter. The light sensors may be included in an electronic device 1410, 1425 associated with persons 1415, 1420. The light sensors sense light color, frequency, intensity, angle or any other measurable light property. The information sensed by the light sensors may be shared among the measured devices and the measuring device as disclosed above. The light sensors may sense light penetrating from a window, or from a light emitting device.

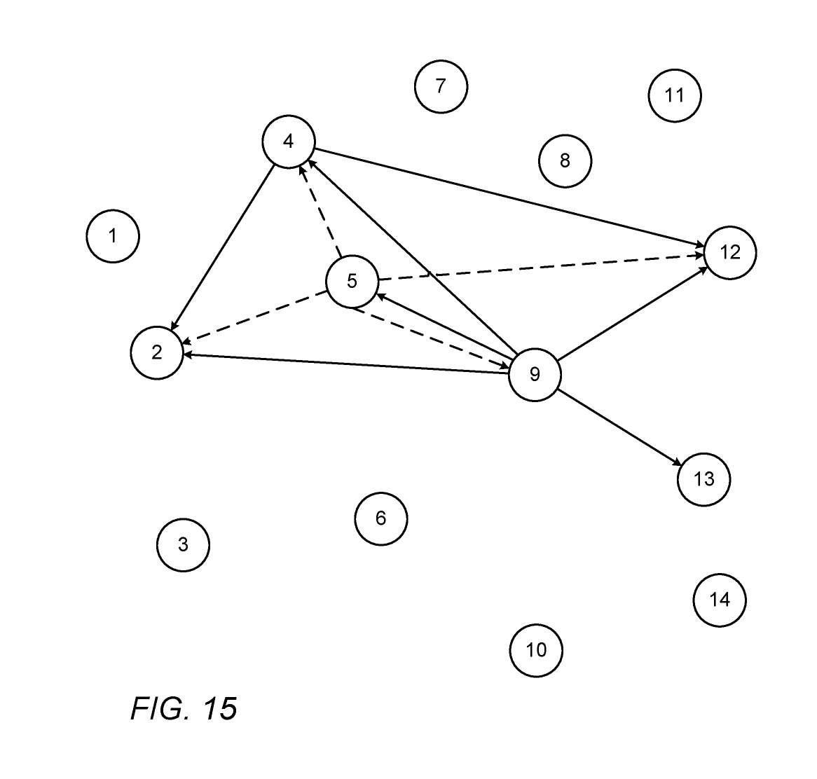

FIG. 15 shows a group of devices assessing a relative distance of each other, according to exemplary embodiments of the disclosed subject matter. Each device can determine the Relative Distance of other devices, but by sharing the Relative direction data between the devices in the system, a schematic map of Relative Distances can be created.

The invention also discloses the integration of the methods described above—in whole or in part. For example, the process of changing the attenuation can be applied for selective rates. In another example, RF Relative Distance methods may be applied together with a method of assessing Relative Distance using data detected by sensors. Integration of methods can improve reliability of each method, and provide more accurate and stable result.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method to determine the relative distance between electronic devices, by having a main electronic device communicating with at least two electronic devices in a wireless manner, the method comprising:
changing in a controlled manner a communication parameter used in the wireless communication between the main device and the said electronic devices;
conducting wireless communication between said main device to each of the said other devices after each change of parameter;
logging if receiving wireless signals from each one of the said two electronic devices for each said change of the communication parameter in said changed state;
determining at the main electronic device that one of the at least two electronic devices is closer or further-away than the other electronic device of the at least two electronic devices in relation to the main device.

2. The method of claim 1, further comprises changing in a controlled manner the communication parameter in the main electronic device and in one of the at least two electronic devices correspondingly.

3. The method of claim 1, wherein changing in a controlled manner a communication parameter comprises increasing or decreasing a value of the communication parameter.

4. The method of claim 1, wherein determining that one of the at least two electronic devices is closer than the other electronic device is achieved when communication between the main electronic device and another device reaches a predefined threshold.

5. The method of claim 4, wherein the predefined threshold is loss of communication between the main electronic device and another device.

6. The method of claim 4, further comprises marking a communication parameter value in which the communication between the main electronic device and another electronic device of the at least two electronic devices reaches the predefined threshold.

7. The method of claim 1, further comprises displaying on a display device of the main electronic device the said other devices in their relative distance from the main device.

8. The method of claim 1, wherein the method is performed by one of the at least two electronic devices simultaneously to the method performed by the main electronic device.

9. The method of claim 8, further comprises sharing and comparing relative distances between the main electronic device and one of the at least two electronic devices.

10. The method of claim 8, further comprises determining whether or not the results of the methods performed the main electronic device and one of the at least two electronic devices match.

11. The method of claim 1, wherein the communication parameter is bitrate.

12. The method of claim 1, wherein the communication parameter is an attenuation level.

13. The method of claim 1, wherein the communication parameter is Power Adjustment Back-off, and wherein the Power Adjustment Back-off value is broadcasted by the said two other devices while changed.

14. The method of claim 1, wherein the communication parameter is a radio frequency of the wireless communication.

15. The method of claim 1, wherein the communication parameter is an audio frequency of the wireless communication.

16. The method of claim 1, wherein the communication parameter is a light frequency of the wireless communication.

17. The method of claim 1, further comprises capturing an image and analyzing the captured image;
wherein determining at the main electronic device that one of the at least two electronic devices is closer or further-away than the other electronic device of the at least two electronic devices in relation to the main device is performed according to the analysis of the captured image.

18. A method performed in a system having at least 3 electronic devices communicating with each other in a wireless manner, the method comprising;
determining at each electronic device a relative direction to at least two electronic devices;
sharing the relative direction determined electronic devices with other;
determining at said electronic devices that one of the other two electronic devices is closer than the other electronic device.

19. The method of claim 18, wherein plurality of devices in the system can determine the relative direction to other devices and share said data among the devices.

20. The method of claim 19, wherein the relative direction comprises an azimuth from one electronic device to another.

21. A method performed on a main electronic device communicating with at least two electronic devices in a wireless manner, the method comprising:
tracking a communication parameter used to communicate with the at least two electronic devices;
receiving wireless signals from the at least two electronic devices in various values of the communication parameter;
determining at the main electronic device that one of the at least two electronic devices is closer than another electronic device of the at least two electronic devices.

22. A method, comprising:
emitting an environmental-detectable material from an emitting device;
wirelessly broadcasting the parameters of the emitted environmental-detectable material by the emitting device;
measuring the environmental-detectable material parameters by a device having at least one sensor;
receiving at the said device the wirelessly broadcasted parameters from the emitting device;
comparing at the measuring device the measured parameters to the broadcasted parameters;
determining a relative distance of the sensor from the device according to said comparison.

23. The method of claim 22, wherein said sensor detects air movement velocity.

24. The method of claim 22, wherein the detectable material is air, gas, temperature, light and a combination thereof.
